(19) United States
(12) Patent Application Publication
(10) Pub. No.: US 2013/0121661 A1
(43) Pub. Date: May 16, 2013

(54) Method of playing content on a digital media renderer and related computer system

(71) Applicant: MingXiang Shen, Hangzhou City (CN)

(72) Inventor: MingXiang Shen, Hangzhou City (CN)

(21) Appl. No.: 13/296,244

(22) Filed: Nov. 15, 2011

(51) Int. Cl. H04N 5/775

(52) U.S. Cl. 386/230; 386/E05.002

(57) ABSTRACT

A method of playing content on a digital media renderer (DMR) includes installing a virtual DMR on a computer, the virtual DMR being a software application installed to run on an operating system of the computer and executed by a processor of the computer, and associating a real DMR device with the virtual DMR. The method further includes displaying details corresponding to the real DMR device in a charm sidebar of the operating system, where the real DMR device does not have certification to be installed on the operating system and the virtual DMR does have certification to be installed on the operating system, receiving a command from a user through the charm sidebar for indicating an action to perform on the real DMR device, and the virtual DMR transferring the command from the user to the real DMR device for executing the command on the real DMR device.

### BACKGROUND OF THE INVENTION

1. Field of the Invention

The invention relates to a digital media renderer (DMR), and more particularly, to a method of playing content on a DMR using a virtual DMR installed on a computer.

2. Description of the Prior Art

The soon-to-be-released Windows 8 operating system produced by Microsoft Corporation contains a “Play To” function for allowing a computer user to conveniently send photos, audio, videos, and so on directly over a local network to a television (TV) or other networked device. The networked devices can be in communication with the computer through either a wired network or a wireless network.

In this way, users can share locally-stored content from the computer or share content located on the Internet to a digital media renderer (DMR) device such as a TV for playback. The content is transmitted using the Digital Living Network Alliance (DLNA) protocol for playback. Users first select the content they wish to play, and then using a charm sidebar of the Windows 8 operating system, a desired playback DMR device is selected in order to play the content on the selected DMR device using the Play To function. According to the DLNA specifications a DMR, such as a TV, can be controlled by a digital media controller (DMC) for playing content sent from a digital media server (DMS). As an example, the computer can serve as both the DMC and the DMS, although other devices can be used instead.

The charm sidebar lists all of the DMR devices connected to or in communication with the computer. The charm represent operating system settings that can be accessed by applications, such as the toolbar application.

Unfortunately, in order for a DMR device to be displayed in the charm sidebar listing, it needs to have device certification for the Windows 8 operating system. For some products already being sold in the market, receiving certification after the product is released on the market is difficult. This is especially true since in order to receive Windows 8 certification, DMR devices need to support photo, audio, and video formats, which may prove to be overly strict requirements for many devices. Some DMR devices, such as the majority of TVs that can only support the Moving Picture Experts Group-2 (MPEG-2) video format and not other formats such as H.264, can not be upgraded without upgrading the hardware of the DMR devices in order to achieve such support.

### SUMMARY OF THE INVENTION

It is therefore one of the primary objectives of the claimed invention to provide a method of playing content on a digital media renderer (DMR) and a related computer system for playing content on a DMR.

According to an exemplary embodiment of the claimed invention, a method of playing content on a DMR is disclosed. The method includes installing a virtual DMR on a computer, the virtual DMR being a software application installed to run on an operating system of the computer and executed by a processor of the computer, and associating a real DMR device with the virtual DMR. The method further includes displaying details corresponding to the real DMR device in a charm sidebar of the operating system, wherein the real DMR device does not have certification to be installed on the operating system and the virtual DMR does have certification to be installed on the operating system, receiving a command from a user through the charm sidebar for indicating an action to perform on the real DMR device, and the virtual DMR transferring the command from the user to the real DMR device for executing the command on the real DMR device.

According to another exemplary embodiment of the claimed invention, a computer system for playing content on a DMR in communication with the computer system includes a memory, an operating system of the computer stored in the memory, and a virtual DMR being a software application installed to run on the operating system, a real DMR device being associated with the virtual DMR. The computer system also includes a display for displaying details corresponding to the real DMR device in a charm sidebar of the operating system, wherein the real DMR device does not have certification to be installed on the operating system and the virtual DMR does have certification to be installed on the operating system, a user interface receiving a command from a user through the charm sidebar for indicating an action to perform on the real DMR device, and a processor executing the virtual DMR and causing the virtual DMR to transfer the command from the user to the real DMR device for executing the command on the real DMR device.

It is an advantage that the present invention utilizes a virtual DMR to communicate with real DMR devices in order to allow users to play content on the real DMR devices that the user would otherwise not be able to use through the computer running the Windows 8 operating system. The virtual DMR, which has charm certification for the Windows 8 operating system, connects to the real DMR devices and allows the user to conveniently and quickly connect to real DMR devices for playing content on the real DMR devices. In this way a wider variety of devices, including older or relatively less expensive real DMR devices, can be used for playing content via the virtual DMR.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a computer system containing a virtual DMR in communication with a real DMR device according to the present invention.

FIG. 2 is a screen showing a user accessing the charm sidebar on a non-touch computer.

FIG. 3 is a screen showing a user accessing the charm sidebar on a touch computer such as a tablet computer.

FIG. 4 is a screen showing the charm sidebar after the user has pressed the Devices option in the charm sidebar shown in FIG. 2 or FIG. 3.

FIG. 5 is a screen showing the charm sidebar after the user has clicked on the icon corresponding to the virtual DMR shown in FIG. 4.

FIG. 6 is a flowchart describing the method of playing content on a real DMR device via the virtual DMR according to the present invention.

### DETAILED DESCRIPTION

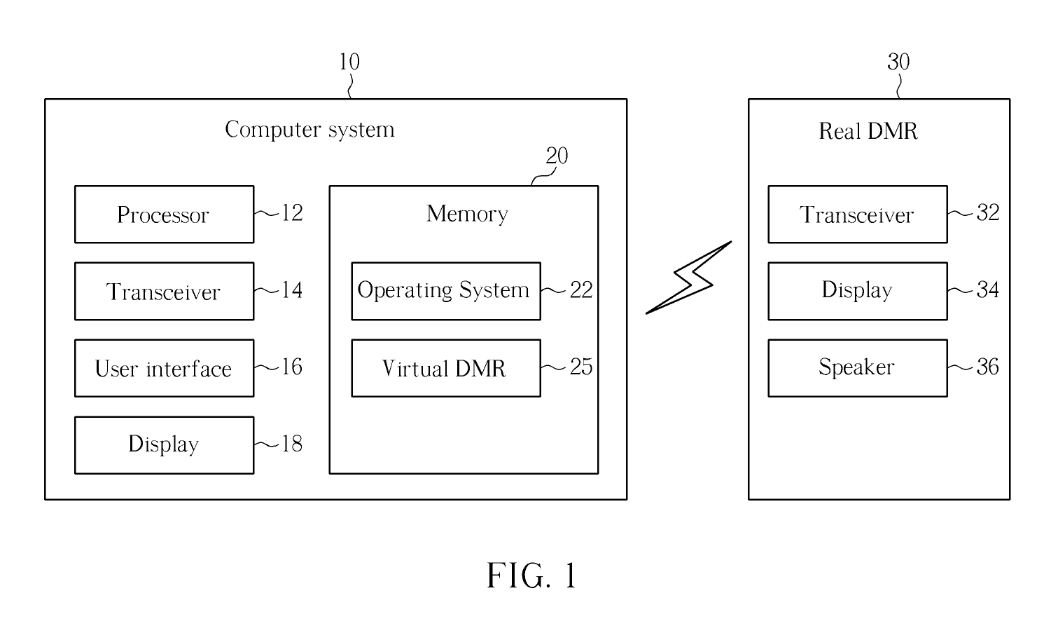

Please refer to FIG. 1. FIG. 1 is a block diagram of a computer system 10 containing a virtual DMR 25 in communication with a real DMR device 30 according to the present invention. The computer system 10 contains a processor 12 for controlling operation of the computer system 10, a transceiver 14 for communicating with the real DMR device 30, a user interface 16 for receiving commands from a user, a display 18 for displaying data to a user, and a memory 20. The memory 20 is used to store an operating system 22, such as the Windows 8 operating system produced by the Microsoft Corporation, as well as the virtual DMR 25. Both the operating system 22 and the virtual DMR 25 are software instructions executed by the processor 12.

The real DMR device 30 comprises a transceiver 32, a display 34, and a speaker 36. In the following description, the real DMR device 30 will be described as being a television (TV), although in practice the real DMR device 30 can be any networked DMR that can output media transmitted from the computer system 10. The transceiver 14 and the transceiver 32 can transmit and receive data through a wired connection or a wireless connection.

The present invention aims to use the virtual DMR 25 that can be added to a charm sidebar of the Windows 8 operating system, through which the user can select real DMR devices that have not received certification for the Windows 8 operating system. Additionally these real DMR devices, which would ordinarily not be able to support user content in an original file format, can be used for playing back the user content through a format conversion, also known as transcoding.

The virtual DMR 25 is a service program that can be run in the Windows 8 operating system, in the Windows 7 operating system, in the Windows Vista operating system, and in the Windows XP operating system. The virtual DMR 25 appears as DMR equipment in the Digital Living Network Alliance (DLNA) environment, and the virtual DMR 25 can provide access to one or more real DMR devices. The virtual DMR 25 has certification for the Windows 8 operating system, and can therefore be added to the charm sidebar in the Windows 8 operating system.

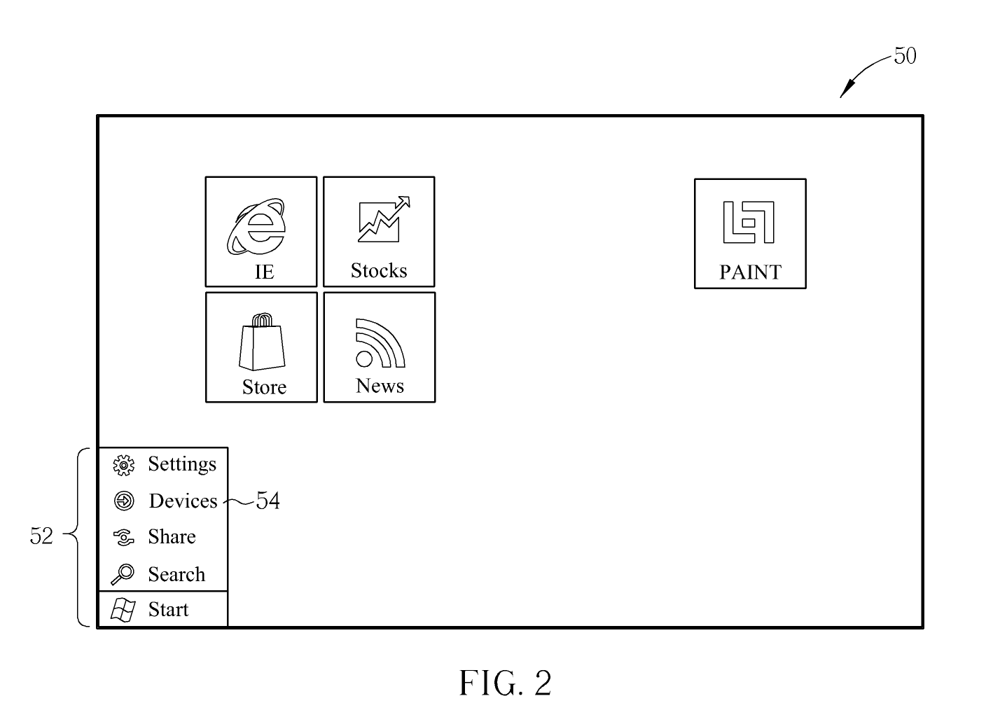

In order to access the charm sidebar, a command is given by the user. Please refer to FIG. 2. FIG. 2 is a screen 50 showing a user accessing the charm sidebar 52 on a non-touch computer. On an ordinary non-touch computer, the charm sidebar 52 is accessed by dragging the mouse to the bottom-left corner of the screen, which is the same spot as the Windows start button on previous versions of the Windows operating system. In the charm sidebar 52 five options are presented to the user: a Start option, a Search option, a Share option, a Devices option 54, and a Settings option. The Start option returns the user to the home screen. The Search option allows the user to search for keywords. Under the Share option, the user can see social network sharing apps. The Devices option 54 presents a list of connected devices. The Settings option allows the user to change settings of the computer.

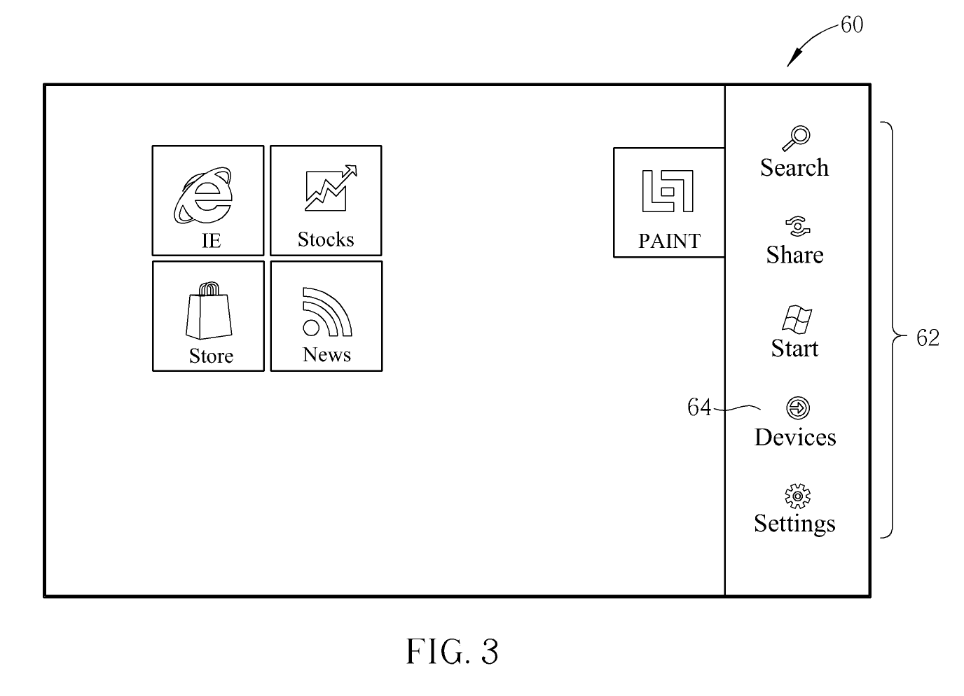

Please refer to FIG. 3. FIG. 3 is a screen 60 showing a user accessing the charm sidebar 62 on a touch computer such as a tablet computer. On a tablet computer, the user accesses the charm sidebar 62 by swiping from the right side of the screen to bring up the charm sidebar. The charm sidebar 62 contains the same five options shown in the charm sidebar 52 shown in FIG. 2, and the Devices option 64 can be selected for allowing the user to see a list of connected devices.

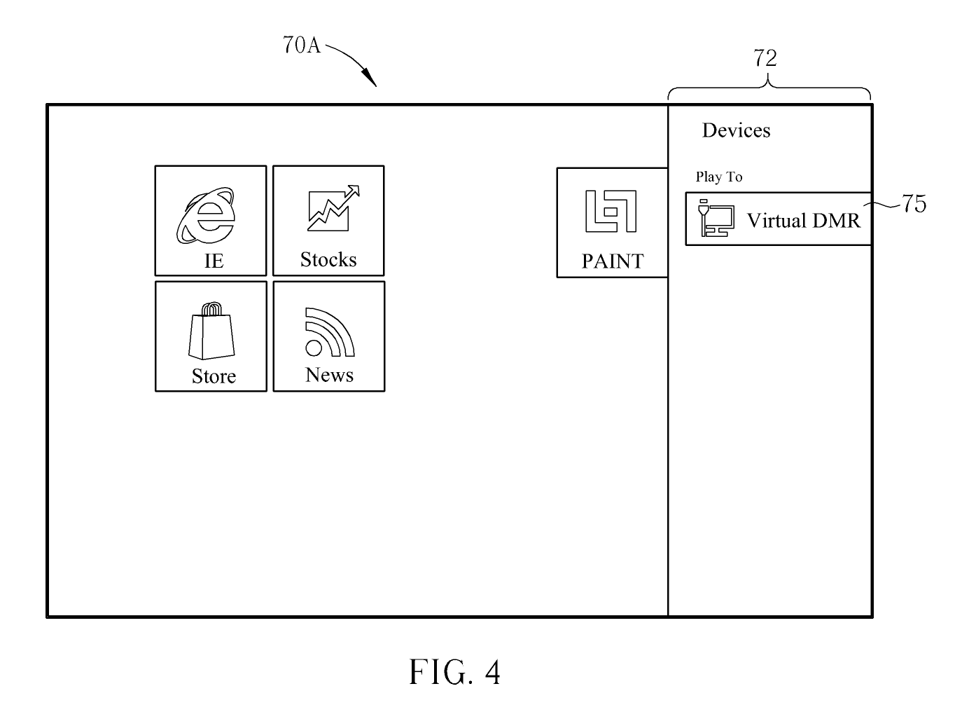

Please refer to FIG. 4. FIG. 4 is a screen 70A showing the charm sidebar 72 after the user has pressed the Devices option 54 or 64 in the charm sidebar 52 or 62 shown in FIG. 2 or FIG. 3. After the Devices option 54 or 64 is selected, the charm sidebar 72 shows a list of devices that can be used to execute the Play To function for outputting data to a connected DMR device. In this case, the only device shown in the list of devices is an icon 75 corresponding to the virtual DMR 25. Since the virtual DMR 25 has received certification for the Windows 8 operating system, the icon 75 corresponding to the virtual DMR 25 can be added to the list of devices that can perform the Play To function. Since the virtual DMR 25 can be associated with one or more real DMR devices such as the real DMR device 30 shown in FIG. 1, clicking on the icon 75 corresponding to the virtual DMR 25 will bring up a list of all associated real DMR devices.

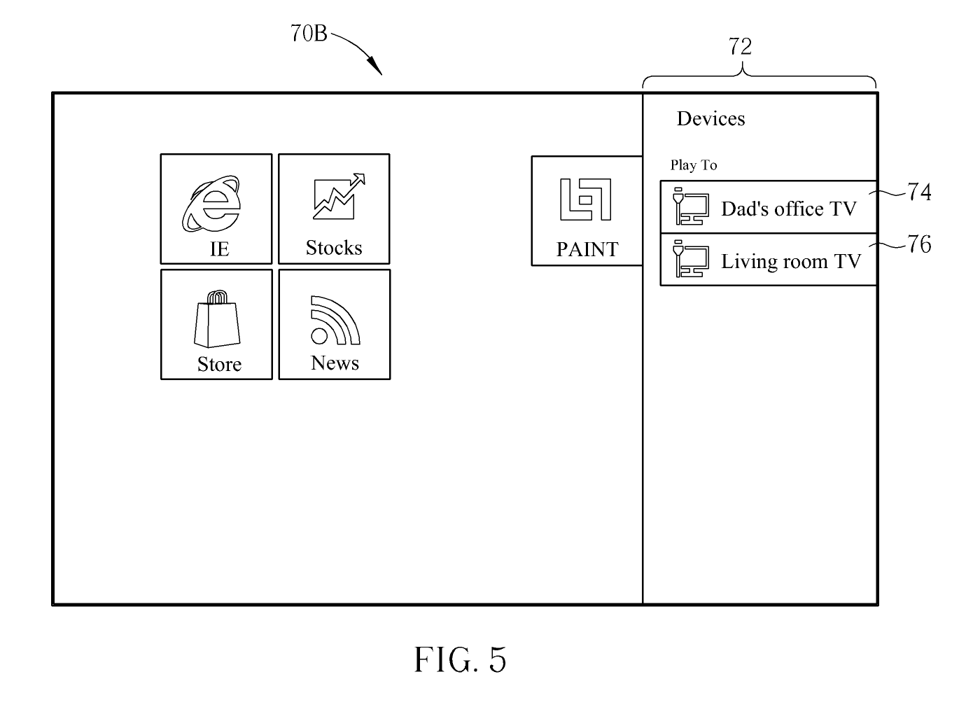

Please refer to FIG. 5. FIG. 5 is a screen 70B showing the charm sidebar 72 after the user has clicked on the icon 75 corresponding to the virtual DMR 25 shown in FIG. 4. In this example, the charm sidebar 72 displays two real DMR devices 74 and 76 associated with the virtual DMR 25. These two real DMR devices 74 and 76 are labeled “Dad's office TV” and “Living room TV”, respectively. The user can then select one of these two real DMR devices 74 and 76 for outputting content from the computer system 10. Please note that instead of the user manually selecting a real DMR device associated with the virtual DMR 25, the virtual DMR 25 can automatically select a preset real DMR device for the user.

The virtual DMR 25 will map to each real DMR device in a one-to-one mapping, and the virtual DMR 25 will use a name, icon, and other descriptive information corresponding to the real DMR device. This will allow the user to clearly understand which real DMR device the listing corresponds to. Since the virtual DMR 25 has already received Windows 8 operating system certification, these listings corresponding to the real DMR devices will be automatically added to the charm sidebar 72 when the virtual DMR 25 is selected by through the icon 75. The user can then select a real DMR device through the charm sidebar 72 in order to execute the Play To function on the selected real DMR device.

When the virtual DMR 25 receives a control command from the user, such as specifying the content to be played, a play command, a pause command, a stop command, and so on, the virtual DMR 25 will send the control commands to the associated real DMR device through the DLNA protocol.

The virtual DMR 25 will continuously monitor the condition of the real DMR device used for to play user content, which is accomplished by the real DMR device providing feedback to the virtual DMR. When there is a status change in the real DMR device, the virtual DMR 25 will send out a DLNA-based broadcast regarding the status change. All devices connected through the DLNA network will receive the broadcast. As a result, the Play To program in the Windows 8 operating system will also receive an update about the status change of the playback device, and can react or respond accordingly.

When a real DMR device does not support the playback of the original content that the user wishes to play on the real DMR device, the virtual DMR 25 will transcode original content into a format that the real DMR device is able to and then transmit the transcoded content to the real DMR device for playback. For instance, if the original content is in the H.264 video format, which the selected real DMR device does not support, the virtual DMR 25 can transcode the original content into the MPEG-2 format that the selected real DMR device does support. After transcoding, the virtual DMR 25 will transfer to the transcoded content in the MPEG-2 format to the selected real DMR device for playback.

The virtual DMR 25 will determine whether the selected real DMR device can support playback of the content to be played according to the properties of the selected real DMR device stored in the virtual DMR 25. If the selected real DMR device can support playback of the original content, the virtual DMR 25 will transmit the original content to the selected real DMR device directly. If not, the virtual DMR 25 will select another format that is supported by the selected real DMR device, transcode the content into the supported format, and then transmit the transcoded content to the selected real DMR device. In this way, the selected real DMR device will be able to properly play the content even despite not supporting the format that the original content was in.

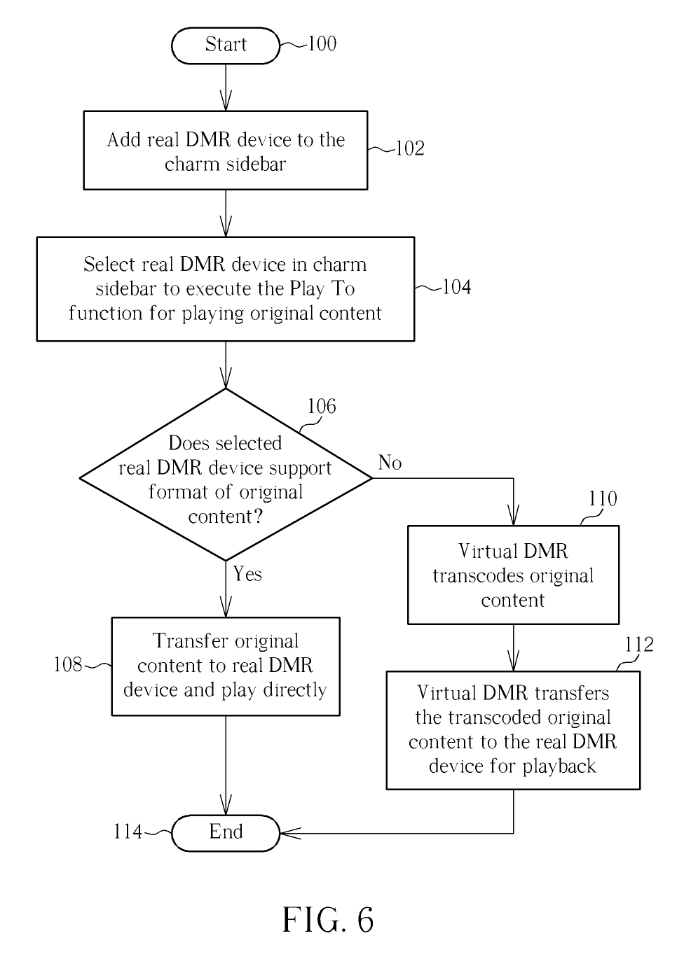

Please refer to FIG. 6. FIG. 6 is a flowchart describing the method of playing content on a real DMR device via the virtual DMR 25 according to the present invention. Steps in the flowchart will be explained as follows.

Step 100: Start.

Step 102: Add at least one real DMR device to the charm sidebar of the Windows 8 operating system by associating the real DMR device with the virtual DMR 25.

Step 104: Select a real DMR device in the charm sidebar that will be used for receiving content when the user executes the Play To function on the computer for playing original content.

Step 106: Determine if the selected real DMR device supports the format of the original content. If so, go to step 108. If not, go to step 110.

Step 108: Transfer the original content from the virtual DMR 25 to the selected real DMR device and play the original content on the selected real DMR device directly. Afterwards go to step 114.

Step 110: The virtual DMR 25 transcodes the original content into a format that the selected real DMR device supports.

Step 112: The virtual DMR 25 transfers the transcoded original content to the selected real DMR device for playback on the selected real DMR device.

Step 114: End.

In summary, the present invention uses a virtual DMR to communicate with real DMR devices in order to allow users to play content on the real DMR devices that the user would otherwise not be able to sent content to through the computer running the Windows 8 operating system. The virtual DMR has charm certification for the Windows 8 operating system, and connects to the real DMR devices for allowing the user to conveniently and quickly connect to real DMR devices to play content on the real DMR devices. In this way a large number of real DMR devices can be used for playing content through the virtual DMR installed on the computer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of playing content on a digital media renderer (DMR), the method comprising:
installing a virtual DMR on a computer, the virtual DMR being a software application installed to run on an operating system of the computer and executed by a processor of the computer;
associating a real DMR device with the virtual DMR;
displaying details corresponding to the real DMR device in a charm sidebar of the operating system, wherein the real DMR device does not have certification to be installed on the operating system and the virtual DMR does have certification to be installed on the operating system;
receiving a command from a user through the charm sidebar for indicating an action to perform on the real DMR device; and
the virtual DMR transferring the command from the user to the real DMR device for executing the command on the real DMR device.

2. The method of claim 1, wherein the command is a play command, a stop command, or a pause command for playing original content stored in the computer on the real DMR device.

3. The method of claim 1, wherein the command is a play command for playing original content stored in the computer on the real DMR device.

4. The method of claim 3, wherein when the real DMR device supports a format type of the original content to be played, the virtual DMR transfers the original content to the real DMR device for playing the original content on the real DMR device directly.

5. The method of claim 3, wherein when the real DMR device does not support a format type of the original content to be played, the virtual DMR transcodes the original content to a format type supported by the real DMR device and transfers the transcoded original content to the real DMR device for playing the transcoded original content on the real DMR device.

6. The method of claim 5, wherein when the original content is in a H.264 format type not supported by the real DMR device, the virtual DMR transcodes the original content into a Moving Picture Experts Group-2 (MPEG-2) format type supported by the real DMR device and transfers the transcoded original content to the real DMR device for playing the transcoded original content on the real DMR device.

7. The method of claim 1, wherein multiple real DMR devices are associated with the virtual DMR, each real DMR device being listed individually in the charm sidebar along with details corresponding to the real DMR device.

8. The method of claim 7, wherein the multiple real DMR devices are associated with the virtual DMR in a one-to-one mapping and an icon and a name of each real DMR device is shown in the charm sidebar.

9. The method of claim 1, wherein the operating system is the Windows 8 operating system produced by Microsoft Corporation.

10. The method of claim 9, wherein the virtual DMR has charm certification for the Windows 8 operating system.

11. A computer system for playing content on a digital media renderer (DMR) in communication with the computer system, the computer system comprising:
a memory;
an operating system of the computer system stored in the memory;
a virtual DMR being a software application installed to run on the operating system, a real DMR device being associated with the virtual DMR;
a display for displaying details corresponding to the real DMR device in a charm sidebar of the operating system, wherein the real DMR device does not have certification to be installed on the operating system and the virtual DMR does have certification to be installed on the operating system;
a user interface receiving a command from a user through the charm sidebar for indicating an action to perform on the real DMR device; and
a processor executing the virtual DMR and causing the virtual DMR to transfer the command from the user to the real DMR device for executing the command on the real DMR device.

12. The computer system of claim 11, wherein the command is a play command, a stop command, or a pause command for playing original content stored in the computer system on the real DMR device.

13. The computer system of claim 11, wherein the command is a play command for playing original content stored in the computer system on the real DMR device.

14. The computer system of claim 13, wherein when the real DMR device supports a format type of the original content to be played, the virtual DMR transfers the original content to the real DMR device for playing the original content on the real DMR device directly.

15. The computer system of claim 13, wherein when the real DMR device does not support a format type of the original content to be played, the virtual DMR transcodes the original content to a format type supported by the real DMR device and transfers the transcoded original content to the real DMR device for playing the transcoded original content on the real DMR device.

16. The computer system of claim 15, wherein when the original content is in a H.264 format type not supported by the real DMR device, the virtual DMR transcodes the original content into a Moving Picture Experts Group-2 (MPEG-2) format type supported by the real DMR device and transfers the transcoded original content to the real DMR device for playing the transcoded original content on the real DMR device.

17. The computer system of claim 11, wherein multiple real DMR devices are associated with the virtual DMR, each real DMR device being listed individually in the charm sidebar along with details corresponding to the real DMR device.

18. The computer system of claim 17, wherein the multiple real DMR devices are associated with the virtual DMR in a one-to-one mapping and an icon and a name of each real DMR device is shown in the charm sidebar.

19. The computer system of claim 11, wherein the operating system is the Windows 8 operating system produced by Microsoft Corporation.

20. The computer system of claim 19, wherein the virtual DMR has charm certification for the Windows 8 operating system.
